(19) United States
(12) Patent Application Publication
(10) Pub. No.: US 2017/0372662 A1
(43) Pub. Date: Dec. 28, 2017

(54) DATA DRIVE CIRCUIT AND DRIVE METHOD THEREFOR, AND ORGANIC LIGHT EMITTING DISPLAY

(71) Applicants: Kunshan Go-Visionox Opto-Electronics Co., Ltd., Jiangsu (CN); Kunshan New Flat Panel Display Technology Center Co., Ltd., Jiangsu (CN)

(72) Inventors: Xiaobao ZHANG, Jiangsu (CN); Hui ZHU, Jiangsu (CN); Siming HU, Jiangsu (CN); Liwei DING, Jiangsu (CN); Xiuqi HUANG, Jiangsu (CN)

(21) Appl. No.: 15/540,252

(22) PCT Filed: Dec. 21, 2015
(86) PCT No.: PCT/CN2015/097996

§ 371 Date: Jun. 27, 2017

(30) Foreign Application Priority Data
Dec. 29, 2014 (CN) 201410834484.X

(51) Int. Cl. G09G 3/3275; G09G 3/3225; G09G 3/3266

(52) U.S. Cl. CPC G09G 3/3275; G09G 3/3225; G09G 2320/0252; G09G 2310/0297; G09G 3/3266; G09G 2330/02; G09G 2310/08

(57) ABSTRACT

A data drive circuit, a drive method for data drive circuit and an organic light emitting display that has the data drive circuit. The data drive circuit has a data signal multiplexing structure, and also comprises a power source line (50) for connecting to a power source (Vref) and second transistors (T2′ . . . Tm′) connected to the power source line (50), the second transistors (T2′ . . . Tm′) have source electrodes electrically connected to the power source line (50), gate electrodes electrically connected to the same line (Sel_1) of the control lines, and drain electrodes respectively electrically connected to different lines (Dj′) of the signal lines at a connection point between a first transistor (T1 . . . Tm) and the display area (40). By connecting a compensation power source (Vref) to the signal lines (D1′ . . . Dm′) for initializing the pixel units (11 . . . mm), the influence of stray capacitance in the pixel units (11 . . . mm) is alleviated, thereby effectively improving the response properties and display properties of an organic light emitting display apparatus equipped with this data drive circuit.

### TECHNICAL FIELD

The present invention pertains to the display technical field, in particular, relates to a data drive circuit and drive method thereof, as well as an organic light emitting display.

### BACKGROUND

Flat panel displays have characteristics of fully planarization, light weight, thin and energy saving, and are an inexorable trend and research focus of development of image displayers. Among various types of flat panel displays, the Active Matrix Organic Light Emitting Display (AMOLED) utilizes self-emitting Organic Light Emitting Diode (OLED) to display images, which has short response time, consumes lower power to be driven, and has better brightness and color purity, therefore, the Organic Light Emitting Display devices has become a focus of the next-generation display devices.

A large type Active Matrix Organic Light Emitting Display apparatus comprises a plurality of pixel units located in areas with crossed scan lines and data lines. As shown in FIG. 1, a traditional Active Matrix Organic Light Emitting Display panel comprises a data driver 20, a scan driver 30 and pixel units 11, 12 . . . nm. The data signal sent from the data driver 20 is provided by a drive chip, usually, one column of pixel units require one data signal, and m columns of pixel units require m data signals D1, D2 . . . Dm. Because the cost of a drive chip is high and is proportional to the area of the drive chip, more data signals would take more chip area and thus increase the cost of the drive chip. Therefore, many companies use data signal multiplexing (Mux/Demux) configurations to reduce the number of drive signals, so as to reduce the area of the drive chip and thus reduce the cost of the drive chip.

FIG. 2 is a schematic diagram of an AMOLED panel that uses a data signal multiplexing configuration, which adds m P-type switch transistors and two other switch transistors to control signals of Sel_1 and Sel_2. In this panel, the number of data signal lines of the data driver is reduced by half, from m to m/2. Experiments indicate that, under certain particular conditions, using an AMOLED panel with a data multiplexing configuration might have problems of display abnormality.

As shown in FIG. 2 and FIG. 3, in a data signal write cycle T1 of the first column of data line: within the time period t1, a switch transistor T1 is switched on, and a high level signal (5V) on a data signal line D1 is transmitted to a signal line D1′ in the display area; within the time period t2, a switch transistor T2 is switched on, and the high level signal on the data signal line D1 is transmitted to a signal line D2′ in the display area. In a data signal write cycle T2 of the second column of data line: within the time period t3, the switch transistor T1 is switched on, a low level on the data signal line D1 is transmitted to the signal line D1′ in the display area, so that the pixel unit 21 is loaded with low level; at this time, the signal line D2′ is in a suspended state, and because of existence of signal line stray capacitance, the signal line D2′ would keep the high level status attained in the time period t1, so that the pixel unit 22 is loaded with high level. Within the time period t4, the switch transistor T2 is switched on to transmit the low level signal on the data signal line D1 to the signal line D2′ in the display area, however, because the pixel unit 22 has already been loaded with high level in the time period t3, the pixel unit 22 cannot effectively receive a low level signal, as a result, the AMOLED panel shows a phenomenon of display abnormality.

In addition, technicians developed an AMOLED panel with another kind of data multiplexing configuration, as shown in FIG. 4, this panel adds m P-type switch transistors and three other switch transistors to control signals of Sel_1, Sel_2 and Sel_3. In this panel the number of data signal lines of the data driver 20 is reduced by ⅔, from m to m/3.

As shown in FIG. 4 and FIG. 5, Sel_1, Sel_2 and Sel_3 are all cyclic signals, S1, S2 . . . Sn are scan lines; Sel_1, Sel_2 and Sel_3 sequentially have low level signals in the time periods t1, t2 . . . t3n, so as to sequentially switch on the switch transistors T1, T2 . . . Tm and thus sequentially distribute the signals on the data driver signal lines D1 . . . D(m/3) to the signal lines D1′ . . . Dm′ in the display area. Like with the data drive circuit in shown in FIG. 2, the AMOLED panel using the data drive circuit shown in FIG. 4 might also have certain problems of display abnormality.

Although in the data drive circuits in FIG. 2 and FIG. 4 , the drive chip area may be reduced, so that the production cost is reduced, there is still a problem of response delay which leads to display abnormality.

### SUMMARY OF THE INVENTION

Accordingly, the present invention intends to solve the problem that the existing data drive circuits of AMOLED have response delay which leads to display abnormality, by providing a data drive circuit and its drive method and application that can effectively improve the response properties of a display apparatus.

In order to solve the above-mentioned technical problem, the present invention adopts the following technical scheme:

A data drive circuit in accordance with the present invention is electrically connected to a data driver via m/i columns of data lines, and electrically connected to a scan driver via n rows of scan lines, wherein,

each data line is connected to i columns of signal lines at an end away from the data driver, each row of the scan lines is electrically connected to a corresponding row of pixel units arranged in a display area, each column of the signal lines is electrically connected to a corresponding column of pixel units arranged in the display area;

a first transistor is connected in a segment within each signal line between the data line and the display area, said data drive circuit further comprises i rows of control lines connected to the data driver;

the i first transistors connected to the same data line respectively have gate electrodes electrically connected to different lines of the control lines;

i is a natural number larger than or equal to 2, m is a non-zero natural number that is an integer multiple of i, n is a non-zero natural number;

said data drive circuit further comprises a power source line and m−m/i second transistors connected to the power source line, the power source line is connected to a power source; the respective second transistors have source electrodes all electrically connected to the power source line, gate electrodes electrically connected to the same line of the control lines, and drain electrodes respectively electrically connected to different lines of the signal lines at a connection point between the first transistor and the display area.

Preferably, the first transistor and second transistor connected to the same signal line have gate electrodes connected to different lines of the control lines.

Preferably, the power source has a voltage value lower than or equal to 0V.

Preferably, all of the first transistors are P-type transistors.

Preferably, all of the second transistors are field effect transistors with the same channel polarity.

More preferably, the second transistors are P-type field effect transistors.

A drive method for the data drive circuit in accordance with the present invention comprises dividing the data signal write cycle of each column of data line into i time periods;

sequentially setting each of the control lines to be low level in each of the time periods;

in the first of the time periods, the second transistor connected to the control line set at low level is switched on, so that the signal line connected to this second transistor is connected to the power source, and the pixel units in the column corresponding to this signal line is initialized.

Preferably, in each of the time periods, the first transistor connected to the control line set at low level is switched on, so that the signal line connected to this first transistor is connected to the data line, and signal is written into the pixel units in the column corresponding to this signal line.

Preferably, the voltage for the initialization is lower than or equal to 0V.

An organic light emitting display in accordance with the present invention comprises the above-mentioned data drive circuit.

The technical schemes of the present invention have the following advantages as compared to the prior arts:

The data drive circuit in accordance with embodiments of the present invention is electrically connected to a data driver via data lines, and electrically connected to a scan driver via scan lines, wherein, each data line is connected to i columns of signal lines at an end away from the data driver, each row of the scan lines is electrically connected to a corresponding row of pixel units arranged in a display area, each column of the signal lines is electrically connected to a corresponding column of pixel units arranged in the display area; a first transistor is connected in a segment within each signal line between the data line and the display area, said data drive circuit further comprises control lines connected to the data driver; the i first transistors connected to the same data line respectively have gate electrodes electrically connected to different lines of the control lines; said data drive circuit further comprises a power source line and m(i-1)/i second transistors, namely m−m/i second transistors, connected to the power source line, the power source line is connected to a power source; the respective second transistors have source electrodes all electrically connected to the power source line, drain electrodes respectively electrically connected to i-1 signal lines among the i signal lines connected to the same data line at a connection point between the first transistor and the display area, and gate electrodes electrically connected to the control line that is not connected to the drain electrode of the same second transistor. By connecting a compensation power source to the signal lines for initializing the pixel units, the influence of stray capacitance in the pixel units is alleviated, thereby effectively improving the response properties and display properties of an organic light emitting display apparatus equipped with this data drive circuit.

### BRIEF DESCRIPTION OF THE DRAWINGS

In order to make the content of the present invention more easy to be understood clearly, hereinafter, detailed description of the present invention is further provided according to specific embodiments of the present invention with reference to the appended drawings, wherein,

FIG. 1 shows a data drive circuit of an organic light emitting display apparatus in prior art;

FIG. 2 shows another data drive circuit of an organic light emitting display apparatus in prior art;

FIG. 3 is a control signal time sequence diagram of the data drive circuits shown in FIG. 2 and FIG. 6;

FIG. 4 shows another data drive circuit of an organic light emitting display apparatus in prior art;

FIG. 5 is a control signal time sequence diagram of the data drive circuits shown in FIG. 4 and FIG. 7;

FIG. 6 shows a data drive circuit described in embodiment 1 of the present invention;

FIG. 7 shows a data drive circuit described in embodiment 2 of the present invention.

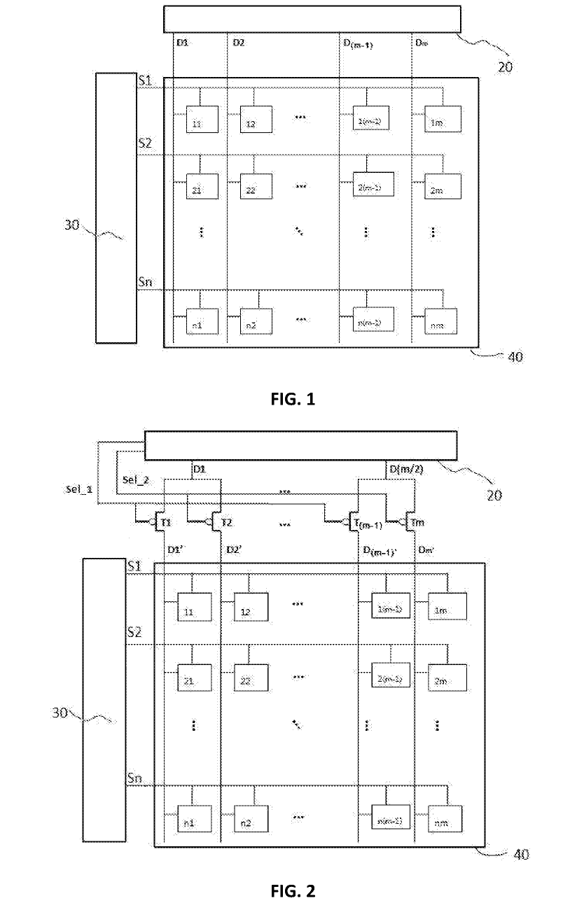

The reference signs in the drawings are listed as follows: 20-data driver, 30-scan driver, 40-display area, 50-power source line, Vref-power source, D1-the first column of data line, D2-the second column of data line, D(m-1)-the number m-1 column of data line, Dm-the number m column of data line, D(m/2)-the number m/2 column of data line, D(m/3)-the number m/3 column of data line, S1-the first row of scan line, S2-the second row of scan line, Sn-the number n row of scan line, D1′-the first column of signal line, D2′-the second column of signal line, D(m-1)′-the number m-1column of signal line, Dm′-the number m column of signal line, T1-the first column of first transistor, T2-the second column of first transistor, T(m-1)-the number m-1column of first transistor, Tm-the number m column of first transistor, T2′-the second column of second transistor, T3′-the third column of second transistor, T(m-1)′-the number m-1column of second transistor, Tm′-the number m column of second transistor, Sel_1-the first row of control line, Sel_2-the second row of control line, Sel_3-the third row of control line; 11, 12, 13 . . . 1(m-2), 1(m-1), 1m, 21, 22, 23 . . . 2(m-2), 2(m-1), 2m . . . n1, n2, n3 . . . n(m-2), n(m-1), nm-pixel units.

### DETAILED DESCRIPTION OF EMBODIMENTS

In order to make the objective, technical scheme and advantages of the present invention more clear, hereinafter, detailed description of implementation ways of the embodiments of the present invention is given below, with reference to the appended drawings.

Specific illustrative embodiments in accordance with the present invention are described below with reference to the appended drawings. Herein, when a first unit is described to be “connected” to a second unit, the first unit may be directly connected to the second unit, or may be indirectly connected to the second unit via one or more additional units. Furthermore, for the sake of clarity, some elements that are not necessary for fully understanding the present invention are omitted. Also, the same reference sign always refers to the same unit.

### Embodiment 1

This embodiment provides a data drive circuit, as shown in FIG. 6, the data drive circuit is electrically connected to a data driver 20 via m/i columns of data lines D1 . . . D(m/2), and electrically connected to a scan driver 30 via n rows of scan lines S1, S2 . . . Sn. In this embodiment, i has a value of 2.

The first column of data line D1 has an end away from the data driver 20 that is connected to a first column of signal line D1′ and a second column of signal line D2′, likewise, the number j column of data line Dj has an end away from the data driver 20 that is connected to a number 2j-1 column of signal line D(2j-1)′ and a number 2j column of signal line D(2j)′, j=1,2,3 . . . m/2; the number m/2 column of data line D(m/2) has an end away from the data driver 20 that is connected to two signal lines of a number m-1 column of signal line D(m-1)′ and a number m column of signal line Dm′. The data drive circuit also comprises pixel units 11, 12, 13 . . . 1(m-2), 1(m-1), 1m, 21, 22, 23 . . . 2(m-2), 2(m-1), 2m . . . n1, n2, n3 . . . n(m-2), n(m-1), nm arranged in a display area 40. In this embodiment, there are n rows, m columns of the pixel units arranged in the display area 40, each row of the scan lines S1, S2 . . . Sn is electrically connected to a corresponding row of pixel units arranged in the display area 40, each column of the signal lines D1′, D2′ . . . D(m-1)′, Dm′ is electrically connected to a corresponding column of pixel units arranged in the display area 40, that is to say, a number m column of signal line Dm′ and a number n row of scan line Sn are connected to a pixel unit nm at Row n Column m.

A first transistor T1, T2 . . . T(m-1), Tm is respectively connected in a segment within each of the signal lines D1′, D2′ . . . D(m-1)′, Dm′ between each of the data lines D1 . . . D(m/2) and the display area 40, said data drive circuit further comprises 2 rows of control lines Sel_1, Sel_2 connected to the data driver 20. These first transistors T1, T2 . . . T(m-1), Tm are preferably P-type transistors.

The gate electrodes of the two first transistors T1, T2 connected to the first column of data line D1 are respectively electrically connected to different lines Sel_1, Sel_2 of the control lines;

likewise, the gate electrodes of the two first transistors T(2j1), T(2j) connected to the same data line Dj are respectively electrically connected to different lines Sel_1, Sel_2 of the control lines, j=1,2,3 . . . m/2;

the gate electrodes of the two first transistors T(m-1), Tm connected to the number m/2 column of data line D(m/2) are respectively electrically connected to different lines Sel_1, Sel_2 of the control lines.

The data drive circuit further comprises a power source line 50 and m/2 second transistors T2′ . . . Tm′ connected to the power source line 50, the power source line 50 is connected to a power source Vref. The power source Vref has a voltage value lower than or equal to 0V, and preferable has a voltage of 0V in this embodiment.

The respective second transistors T2′ . . . Tm′ have source electrodes all electrically connected to the power source line 50, and gate electrodes electrically connected to the same line Sel_1 of the control lines. The drain electrode of the number j column of second transistor Tj′ is electrically connected to the number j column of signal line Dj′ at a connection point between the number j column of first transistor Tj and the display area 40, j=2,4,6 . . . m. That is to say, for example, the second column of second transistor T2′ has a source electrode electrically connected to the power source line 50, and a drain electrode connected to the second column of signal line D2′ at a connection point between the second column of first transistor T2 and the display area 40.

The first transistor T2, T4 . . . T(m-2), Tm and the second transistor T2′, T4′ . . . T(m-2)′, Tm′ connected to the same signal line D2′, D4′ . . . D(m-2)′, Dm′ have their gate electrodes connected to different lines of the control lines, which are Sel_1, Sel_2 in this embodiment. Specifically, in this embodiment, the gate electrode of the second column of second transistor T2′ is electrically connected to the control line Sel_1, while the gate electrode of the first transistor T2 in the same column is electrically connected to the control line Sel_2; . . . the gate electrode of the number m column of second transistor Tm′ is electrically connected to the control line Sel_1, while the gate electrode of the first transistor Tm in the same column is electrically connected to the control line Sel_2.

All of the second transistors T2′ . . . Tm′ are field effect transistors with the same channel polarity, and are preferably P-type field effect transistors in this embodiment.

In other embodiments of the present invention, there can be m/i columns of data lines with i columns of signal lines connected to each column of data line, i rows of control lines, and m(i-1)/i second transistors, namely m-m/i second transistors, wherein i is a natural number larger than or equal to 2, m is a non-zero natural number that is an integer multiple of i. These other embodiments can all achieve the purpose of the present invention, and are embraced in the protection scope of the present invention.

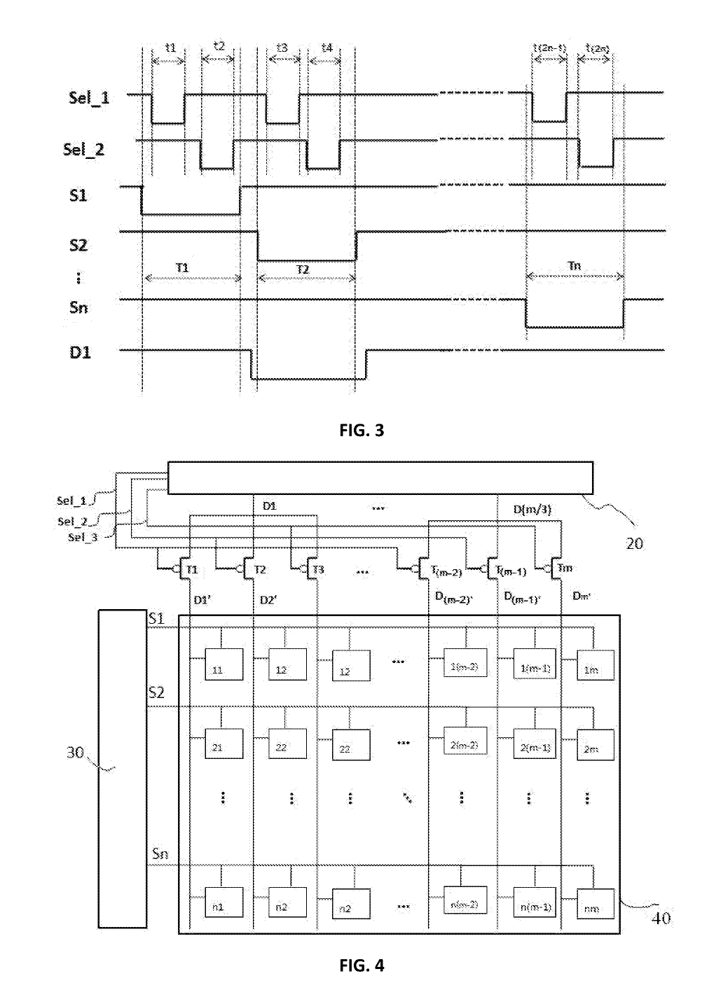

The drive method for the above-mentioned data drive circuit is that, dividing the data signal write cycle (Tj, j=1,2,3 . . . n) of each column of data line into i time periods, preferably 2 time periods (t1, t2) in this embodiment. Taking the second row of pixel units as example, as shown in FIG. 3:

In a data signal write cycle T1 of the first column of data line D1, the first column of data line D1 transmits high level.

Within the time period t1, the control line Sel_1 has low level, the control line Sel_2 has high level, the first column of first transistor T1 and the second column of second transistor T2′ are switched on, while the second column of first transistor T2 is switched off; the high level on the first column of data line D1 is transmitted to the first column of signal line D1′ in the display area 40, and then the data signal on the signal line D1′ is loaded onto the first column of pixel units 11, 21 . . . n1; the second column of signal line D2′ is connected to the power source Vref, so that the second column of signal line D2′ is initialized and the voltage loaded onto the second column of pixel units 12, 22 . . . n2 is 0V.

Within the time period t2, the control line Sel_2 has low level, the control line Sel_1 has high level, the second column of first transistor T2 is switched on, while the first column of first transistor T1 and the second column of second transistor T2′ are switched off; the high level on the first column of data line D1 is transmitted to the second column of signal line D2′ in the display area 40, and then the data signal on the signal line D2′ is loaded onto the second column of pixel units 12, 22 . . . n2.

In a data signal write cycle T2 of the second column of data line D2, the first column of data line D1 transmits low level.

Within the time period t3, the control line Sel_1 has low level, the control line Sel_2 has high level, the first column of first transistor T1 and the second column of second transistor T2′ are switched on, while the second column of first transistor T2 is switched off; the low level on the first column of data line D1 is transmitted to the first column of signal line D1′ in the display area 40, and the first column of pixel units 11, 21 . . . n1 are loaded with low level; the second column of signal line D2′ is connected to the power source Vref, so that the high level on the second column of pixel units 12, 22 . . . n2 that is attained in the data signal write cycle T1 becomes initialized to 0V.

Within the time period t4, the control line Sel_2 has low level, the control line Sel_1 has high level, the second column of first transistor T2 is switched on, while the first column of first transistor T1 and the second column of second transistor T2′ are switched off; the first column of data line D1 transmits low level to the second column of signal line D2′ in the display area 40, and because the voltage on the second column of pixel units 12, 22 . . . n2 has been initialized to 0V within the time period t3, the second column of pixel units 12, 22 . . . n2 are able to effectively receive the low level signal from the second column of signal line D2′.

Therefore, the organic light emitting display apparatus equipped with this data drive circuit is not subjected to stray capacitance in the pixel units or from a signal line, and thus it can respond timely without ghost shadow, so as to display images normally.

### Embodiment 2

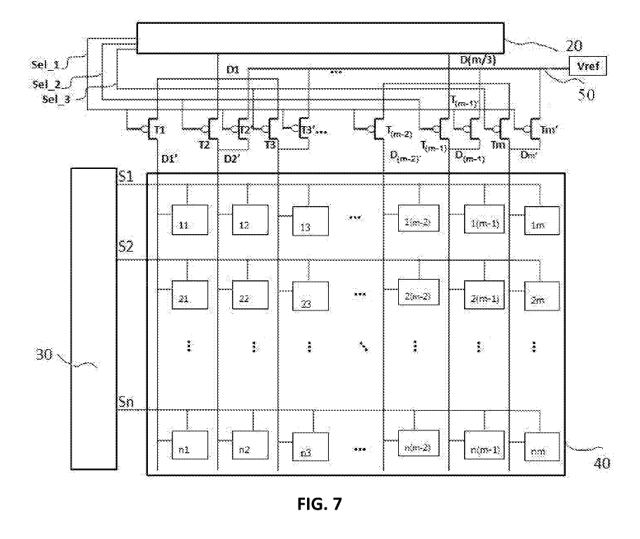

This embodiment provides a data drive circuit, as shown in FIG. 7, its particular circuit configuration is similar to that of Embodiment 1, and the only difference is that i is 3. That is to say, each column of data line has an end away from the data driver 20 that is connected to 3 columns of signal lines, and there are 3 rows of control lines and 2m/3 second transistors, wherein m is a non-zero natural number that is an integer multiple of 3.

In particular, the first column of data line D1 has an end away from the data driver 20 that is connected to a first column of signal line D1′, a second column of signal line D2′ and a third column of signal line D3′, likewise, the number j column of data line Dj has an end away from the data driver 20 that is connected to a number 3j2 column of signal line D(3j2)′, a number 3j1 column of signal line D(3j1)′ and a number 3j column of signal line D(3j′), j=1,2,3 . . . m/3; the number m/3 column of data line D(m/3) has an end away from the data driver 20 that is connected to three signal lines of a number m-2 column of signal line D(m-2)′, a number m-1column of signal line D(m-1)′ and a number m column of signal line Dm′.

First transistors T1, T2 . . . T(m-1), Tm are connected in a segment within the signal lines D1′, D2′ . . . D(m-1)′, Dm′ between the data lines D1 . . . D(m/3) and the display area 40, said data drive circuit further comprises 3 rows of control lines Sel_1, Sel_2, Sel_3 connected to the data driver 20. These first transistors T1, T2 . . . T(m-1), Tm are preferably P-type transistors.

The gate electrodes of the three first transistors T1, T2, T3 connected to the first column of data line D1 are respectively electrically connected to different lines Sel_1, Sel_2, Sel_3 of the control lines;

likewise, the gate electrodes of the three first transistors T(3j2), T(3j1), T(3j) connected to the same data line Dj are respectively electrically connected to different lines Sel_1, Sel_2, Sel_3 of the control lines, j=1,2,3 . . . m/3;

the gate electrodes of the three first transistors T(m-2), T(m-1), Tm connected to the number m/3 column of data line D(m/3) are respectively electrically connected to different lines Sel_1, Sel_2, Sel_3 of the control lines.

The data drive circuit further comprises a power source line 50 and 2m/3 second transistors T2′, T3′ . . . T(m-1)′, Tm′ connected to the power source line 50, the power source line 50 is connected to a power source Vref. The power source Vref has a voltage value lower than or equal to 0V, and preferable has a voltage of 0V in this embodiment.

That is to say, among the 3 signal lines connected to the end of each column of data line that is away from the data driver 20, the latter two signal lines have a second transistor arranged between the respective signal line and the power source line 50. For example, the data line D1 is connected to 3 signal lines D1′, D2′, D3′, wherein the signal lines D2′, D3′ have a second transistor T2′, T3′ arranged between the respective signal line and the power source line 50; and so on, the data line D(m/3) is connected to 3 signal lines D(m-2)′, D(m-1)′, Dm′, wherein the signal lines D(m-1)′, Dm′ have a second transistor T(m-1)′, Tm′ arranged between the respective signal line and the power source line 50.

In particular, the respective second transistors T2′, T3′ . . . T(m-1)′, Tm′ have source electrodes all electrically connected to the power source line 50, and gate electrodes electrically connected to the same line Sel_1 of the control lines. The drain electrode of the number j column of second transistor Tj′ is electrically connected to the number j column of signal line Dj′ at a connection point between the number j column of first transistor Tj and the display area 40, j=2,3,5,6 . . . m-1,m. That is to say, for example, the second column of second transistor T2′ has a source electrode electrically connected to the power source line 50, and a drain electrode connected to the second column of signal line D2′ at a connection point between the second column of first transistor T2 and the display area 40.

The first transistor T2, T3 . . . T(m-1), Tm and the second transistor T2′, T3′ . . . T(m-1)′, Tm′ connected to the same signal line D2′, D3′ . . . D(m-1)′, Dm′ have their gate electrodes connected to different lines of the control lines.

All of the second transistors T2′ . . . Tm′ are field effect transistors with the same channel polarity, and are preferably P-type field effect transistors in this embodiment.

In other embodiments of the present invention, there can be m/i columns of data lines with i columns of signal lines connected to each column of data line, i rows of control lines, and m(i-1)/i second transistors, namely m−m/i second transistors, wherein i is a natural number larger than or equal to 2, m is a non-zero natural number that is an integer multiple of i. These other embodiments can all achieve the purpose of the present invention, and are embraced in the protection scope of the present invention.

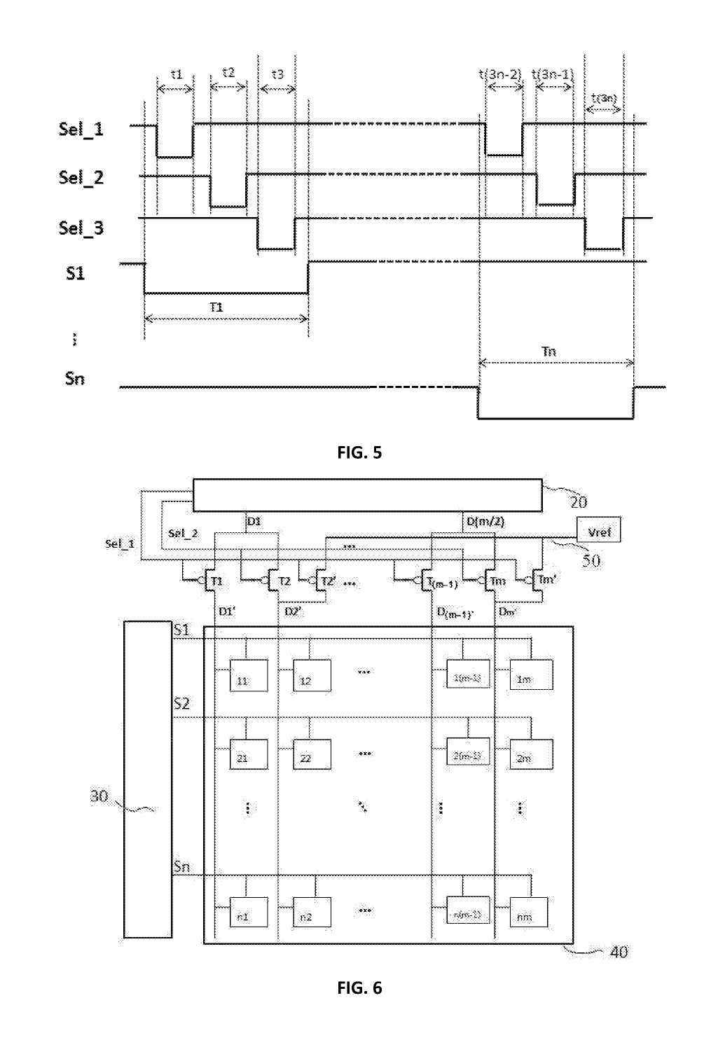

The drive method for the above-mentioned data drive circuit is that, as shown in FIG. 5, dividing the data signal write cycle (Tj, j=1,2,3 . . . n) of each column of data line into 3 time periods.

Within the time period t1, the control line Sel_1 has low level, the control lines Sel_2 and Sel_3 have high level, the first column of first transistor T1, the second column of second transistor T2′ and the third column of second transistor T3′ are switched on, while the second column of first transistor T2 and the third column of first transistor T3 are switched off;

the data signal on the first column of signal line D1′ is loaded onto the first column of pixel units 11, 21 . . . n1; the second column of signal line D2′ and the third column of signal line D3′ are connected to the power source Vref, so that the voltage on the second column of pixel units 12, 22 . . . n2 and on the third column of pixel units 13, 23 . . . n3 are initialized to 0V.

Within the time period t2, the control line Sel_2 has low level, the control lines Sel_1 and Sel_3 have high level, the second column of first transistor T2 is switched on, while the first column of first transistor T1, the second column of second transistor T2′, the third column of first transistor T3 and the third column of second transistor T3′ are switched off;

the electrical level on the first column of data line D1 is transmitted to the second column of signal line D2′ in the display area 40, and then the data signal on the signal line D2′ is loaded onto the second column of pixel units 12, 22 . . . n2.

Within the time period t3, the control line Sel_3 has low level, the control lines Sel_1 and Sel_2 have high level, the third column of first transistor T3 is switched on, while the first column of first transistor T1, the second column of first transistor T2, the second column of second transistor T2′ and the third column of second transistor T3′ are switched off; the data signal on the third column of signal line D3′ is loaded onto the third column of pixel units 13, 23 . . . n3.

Thereby, before the data signal write cycle of the next column of data line begins, the pixel units in the column corresponding to each column of signal line are initialized, so as not to be subjected to stray capacitance in the pixel units or from a signal line, and thus can respond timely without ghost shadow, thereby ensuring normal displaying.

The present invention also provides an organic light emitting display that comprises the above-mentioned data drive circuit. Its specific configurations are not repeatedly described herein. This organic light emitting display is not subjected to stray capacitance in the pixel units or from a signal line, and thus can respond timely without ghost shadow.

Apparently, the aforementioned embodiments are merely examples illustrated for clearly describing the present invention, rather than limiting the implementation ways thereof. For those skilled in the art, various changes and modifications in other different forms can be made on the basis of the aforementioned description. It is unnecessary and impossible to exhaustively list all the implementation ways herein. However, any obvious changes or modifications derived from the aforementioned description are intended to be embraced within the protection scope of the present invention.

2. The data drive circuit of claim 1, wherein, the first transistor and second transistor connected to the same signal line have gate electrodes connected to different lines of the control lines.

3. The data drive circuit of claim 1, wherein, the power source has a voltage value lower than or equal to 0V.

4. The data drive circuit of claim 1, wherein, all of the first transistors are P-type transistors.

5. The data drive circuit of claim 1, wherein, all of the second transistors are field effect transistors with the same channel polarity.

6. The data drive circuit of claim 5, wherein, the second transistors are P-type field effect transistors.

7. The data drive circuit of claim 2, wherein, all of the second transistors are field effect transistors with the same channel polarity.

8. The data drive circuit of claim 3, wherein, all of the second transistors are field effect transistors with the same channel polarity.

9. The data drive circuit of claim 4, wherein, all of the second transistors are field effect transistors with the same channel polarity.

10. A drive method for the data drive circuit of claim 1, wherein, dividing the data signal write cycle of each column of data line into i time periods; sequentially setting each of the control lines to be low level in each of the time periods;
in the first of the time periods, the second transistor connected to the control line set at low level is switched on, so that the signal line connected to this second transistor is connected to the power source, and the pixel units in the column corresponding to this signal line is initialized.

11. The drive method of claim 10, wherein, in each of the time periods, the first transistor connected to the control line set at low level is switched on, so that the signal line connected to this first transistor is connected to the data line, and signal is written into the pixel units in the column corresponding to this signal line.

12. The drive method of claim 10, wherein, the voltage for the initialization is lower than or equal to 0V.

13. An organic light emitting display, characterized in comprising the data drive circuit of claim 1.
